(19) United States
(12) Patent Application Publication
(10) Pub. No.: US 2008/0074051 A1
(43) Pub. Date: Mar. 27, 2008

(54) PLASMA DISPLAY PANEL

(76) Inventors: YUJI KOBAYASHI, Higashimorokata (JP); Osamu Toyoda, Akashi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/740,323

(22) Filed: Apr. 26, 2007

(30) Foreign Application Priority Data
Sep. 27, 2006 (JP) 2006-263264

(51) Int. Cl. H01J 17/49; G09G 3/28

(52) U.S. Cl. 313/582; 313/583; 345/60

(57) ABSTRACT

A plasma display panel includes a discharge gas sealed in a gap between a front side substrate and a rear side substrate opposed to each other, barrier ribs being disposed above an inner surface of one of the substrates and partitioning a gas-sealed space into a discharge cell array, and at least three kinds of phosphor layers of red, green and blue separately applied and provided in the gas-sealed space responding to a discharge cell. The barrier rib is constituted with a colored glass selectively absorbing a light emission spectrum of the red phosphor layer, and whereby a light emitting intensity of the red phosphor layer is weakened to make a difference in a light emission characteristic among respective phosphor layers small so that a difference in a discharge characteristic among respective cells can be decreased without varying a cell structure by each color.

### CROSS-REFERENCE TO RELATED APPLICATIONS

This application is based upon and claims the benefit of priority from the prior Japanese Patent Application No. 2006-263264, filed on Sep. 27, 2006, the entire contents of which are incorporated herein by reference.

### BACKGROUND OF THE INVENTION

1. Field of the Invention

The present invention relates to a plasma display panel.

2. Description of the Related Art

A plasma display device having a plasma display panel (PDP) is in practical use as a flat display device. A surface discharge plasma display panel has a structure in which a front glass substrate on an inner surface of which electrodes for surface discharge is formed and a rear glass substrate on an inner surface of which phosphors of three primary colors of red (R), green (G) and blue (B) are applied are sealed and a rare gas is sealed in between. In the surface discharge plasma display panel, when a predetermined voltage is applied to between the electrodes for the surface discharge, the surface discharge occurs in a discharge cell, and an ultraviolet ray thereby generated excites each phosphor to emit light, and whereby a color image display is performed.

In the plasma display panel performing the color image display, as stated above, there are formed phosphor layers on which phosphors emitting light in red, green and blue respectively in correspondence with luminescent colors of respective discharge cells are applied separately. The ultraviolet ray generated in a discharge space of each discharge cell hits the phosphor layer so that a light of each color applied separately is emitted.

Here, phosphor materials of red, green and blue have different luminance, and in a conventional plasma display panel, there has been adopted a method of varying an applied amount of the phosphor on each discharge cell, namely, a phosphor film thickness, and so on, in order to realize a good color balance. When the phosphor film thickness is varied as above, considering differences in the luminance among the phosphor materials of respective colors, the structure is that a film thickness of the red phosphor is the thinnest and a film thickness of the blue phosphor is the thickest.

However, in the method of varying the phosphor film thickness in correspondence with the luminance of the phosphor material, a discharge inception voltage in each discharge cell differs by the color, because of a difference in a size of the discharge space due to the difference in the phosphor film thickness and a difference in a characteristic of the phosphor material. In particular, the discharge inception voltage in a red cell becomes low in relation to a green cell and a blue cell, and there is a problem that a voltage range (a driving margin) for performing a stable display becomes narrow.

As a technology for improving a discharge characteristic in the plasma display panel, with attention being paid to the characteristic of the phosphor material, there is suggested a technology in which a dielectric layer is provided under a green phosphor layer having the highest discharge inception voltage in a case that film thicknesses are the same and a film thickness of the green phosphor layer is made thin and whereby the difference in the discharge characteristic is made small (for example, see Patent Document 1). However, in this method, it is necessary to increase processes for forming the dielectric layer under the phosphor layer between barrier ribs of stripe ribs determining a line of the specific color, and the method is disadvantage in terms of a manufacturing process. Additionally, in a case of barrier ribs (lattice ribs) in a form of a box structure, it is not easy to apply this method.

[Patent Document 1] Japanese Patent Application Laid-open No. 2003-317630

### SUMMARY OF THE INVENTION

An object of the present invention is to provide a plasma display panel in which a difference in a discharge characteristic among cells of each color is reduced without varying a cell structure by each color.

The plasma display panel of the present invention includes: a discharge gas sealed in a gap between a front side substrate and a rear side substrate opposed to each other; barrier ribs partitioning a gas-sealed space into a discharge cell array, the barrier ribs being disposed above an inner surface of one of the substrates; and at least three kinds of phosphor layers of red, green and blue separately applied and provided in the gas-sealed space responding to a discharge cell, wherein the barrier rib is constituted with a colored glass selectively absorbing a light emission spectrum of the red phosphor layer.

### BRIEF DESCRIPTION OF THE DRAWINGS

FIG. 1 is a diagram showing a configuration example of a plasma display device in an embodiment of the present invention;

FIG. 2 is an exploded perspective view showing a configuration example of a plasma display panel in this embodiment;

FIG. 3 is a cross-sectional view showing a configuration example of the plasma display panel in this embodiment;

FIG. 4A and FIG. 4B are views explaining a display light of the plasma display panel in this embodiment;

FIG. 5 is a cross-sectional view showing another configuration example of a plasma display panel in this embodiment; and

FIG. 6 is a diagram showing an example of a tone drive sequence of a plasma display device in this embodiment.

### DETAILED DESCRIPTION OF THE PREFERRED EMBODIMENTS

Hereinafter, embodiments of the present invention will be described with reference to the drawings.

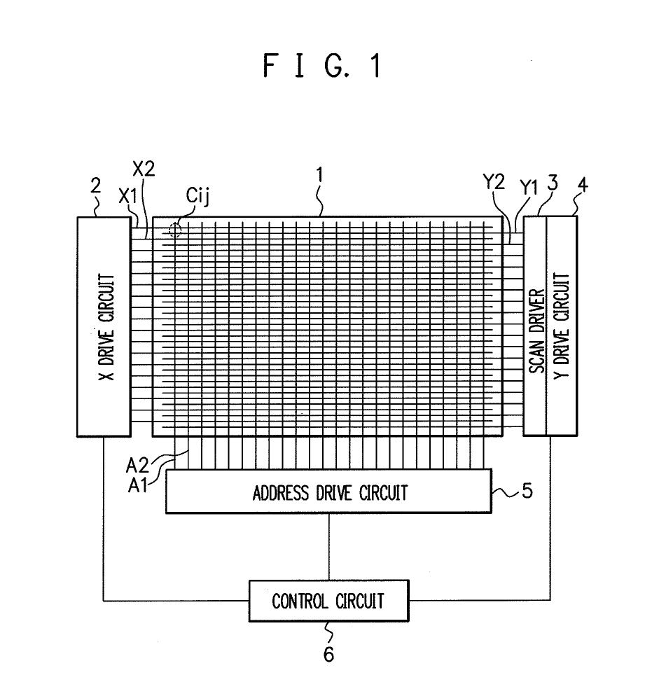

FIG. 1 is a diagram showing a configuration example of a plasma display device in an embodiment of the present invention. The plasma display device in this embodiment has a plasma display panel 1, an X drive circuit 2, a scan driver 3, a Y drive circuit 4, an address drive circuit 5 and a control circuit 6.

The X drive circuit 2 is made of a circuit which repeats sustain discharges. The X drive circuit 2 supplies a predetermined voltage to X electrodes (sustain electrodes) X1, X2 and so on. Hereinafter, the X electrodes X1, X2 and so on are individually or collectively referred to as an X electrode Xi, “i” meaning a subscript.

The scan driver 3 is made of a circuit which selects a row to display by a line-sequential scanning, while the Y drive circuit 4 is made of a circuit which repeats sustain discharges. The scan driver 3 and the Y drive circuit 4 supply a predetermined voltage to Y electrodes (scan electrodes) Y1, Y2 and so on. Hereinafter, the Y electrodes Y1, Y2 and so on are individually or collectively referred to as a Y electrode Yi, “i” meaning a subscript.

The address drive circuit 5 is made of a circuit which selects a column to display. The address drive circuit 5 supplies a predetermined voltage to address electrodes A1, A2 and so on. Hereinafter, the address electrodes A1, A2 ad so on are respectively or collectively referred to as an address electrode Aj, “j” meaning a subscript.

The control circuit 6 generates a control signal based on display data, a clock signal, a horizontal synchronization signal and a vertical synchronization signal which are inputted from external devices such as a TV tuner and a computer. The control circuit 6 supplies the generated control signal to the X drive circuit 2, the scan driver 3, the Y drive circuit 4 and the address drive circuit 5 to control these drive circuits 2 to 5.

In the plasma display panel 1, the Y electrode Yi and the X electrode Xi form rows extending parallelly in a horizontal direction while the address electrode Aj forms a column extending in a vertical direction. The Y electrode Yi and the X electrode Xi are alternately disposed in a vertical direction to constitute display lines. In other words, the Y electrode Yi and the X electrode Xi are disposed parallel to each other and the address electrode Aj is disposed in a direction approximately vertical to the Y electrode Yi and the X electrode Xi. The Y electrode Yi and the address electrode Aj form a two-dimensional matrix of row i and column j.

A discharge cell Cij is formed by an intersection of the Y electrode Yi and the address electrode Aj as well as the adjacent X electrode Xi corresponding thereto. The discharge cells Cij correspond to sub-pixels of red, green and blue, and the sub-pixels of three colors constitute one pixel. The plasma display panel 1 displays an image by lighting of a plurality of pixels arranged two-dimensionally. The scan driver 3 and the address drive circuit 5 determine which discharge cell to light, the X drive circuit 2 and the Y drive circuit 4 repeatedly performs discharges, and whereby a display operation in the plasma display device is performed.

In other words, the scan driver 3 sequentially applies scan pulses to the Y electrode Yi during an address period (an address process) to select the Y electrode Yi (the display line), and makes an address discharge which selects lighting (light emission)/non-lighting (non light emission) of the cell to be generated between the address electrode Aj connected to the address drive circuit 5 and each Y electrode Yi. During a sustain period (a display process), the X drive circuit 2 and the Y drive circuit 4 make the cell selected by the address discharge generate sustain discharges by a number of times corresponding to a weight of each sub-field.

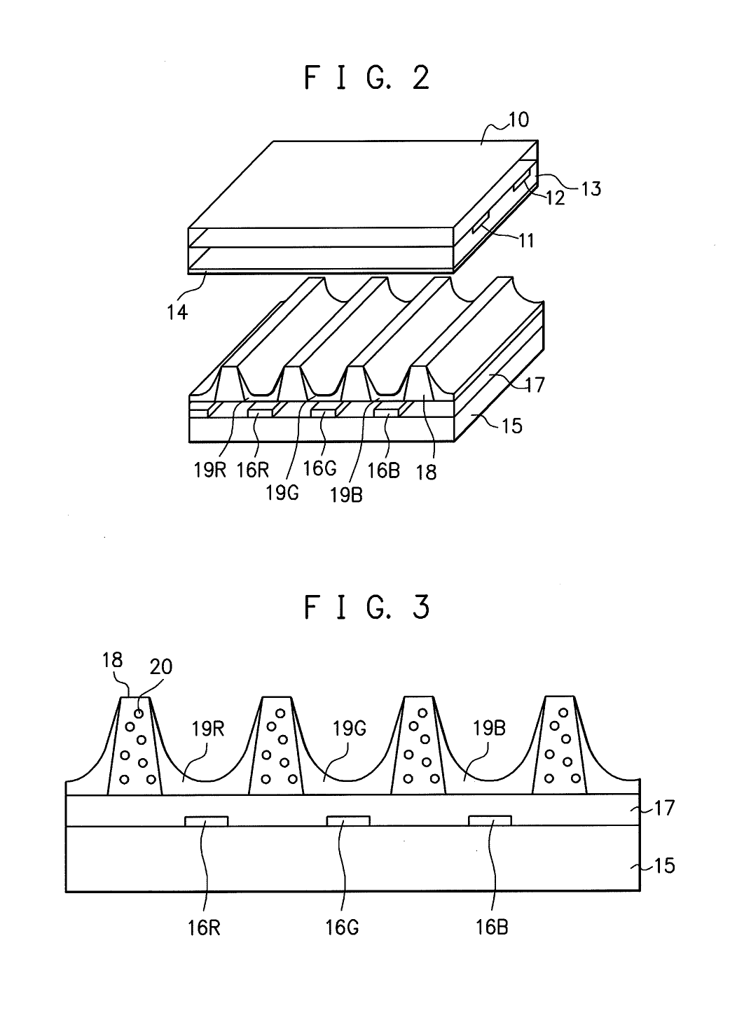

FIG. 2 is an exploded perspective view showing a configuration example of the plasma display panel 1 in this embodiment.

An X electrode (a sustain electrode) 11 corresponds to the X electrode Xi shown in FIG. 1 and a Y electrode (a scan electrode) 12 corresponds to the Y electrode Yi shown in FIG. 1. The X electrode 11 and the Y electrode 12 are disposed and formed parallel to each other on a front glass substrate 10. Thereon is deposited a dielectric layer 13 made of a low-melting glass or the like. Further thereon is deposited an MgO (magnesium oxide) protective layer 14. In other words, the X electrode 11 and the Y electrode 12 disposed on the front glass substrate 10 are covered by the dielectric layer 13, whose surface is further covered by the protective layer 14.

Address electrodes 16R, 16G, 16B correspond to the address electrodes Aj shown in FIG. 1. The address electrodes 16R, 16G, 16B are formed on a rear glass substrate 15 disposed opposed to the front glass substrate 10, in a direction orthogonal to the X electrode 11 and the Y electrode 12 (in an intersecting manner). On the address electrodes 16R, 16G, 16B is deposited a dielectric layer 17. Further thereon are deposited phosphors 19R, 19G, 19B. On both sides of the address electrodes 16R, 16G, 16B are disposed barrier ribs 18 for partitioning cells of the column direction. On inner surfaces (side walls) of the barrier ribs 18 are arranged and applied phosphors 19R, 19G, 19B by each color, the phosphors emitting visible light in red (R), green (G) and blue (B) when exited by an ultraviolet ray.

More specifically, the phosphor layer 19R emitting light in red is formed above the address electrode 16R, the phosphor layer 19G emitting light in green is formed above the address electrode 16G, and the phosphor layer 19B emitting light in blue is formed above the address electrode 16B. In other words, the address electrodes 16R, 16G, 16B are disposed in a manner to correspond to the phosphor layers 19R, 19G, 19B of red, green and blue which are applied on the inner surfaces of the barrier ribs 18.

In other words, the address electrodes 16R, 16G, 16B disposed on the rear glass substrate 15 are covered by the dielectric layer 17, and the barrier ribs 18 are disposed on both sides of the address electrodes 16R, 16G, 16B. The phosphor layer 19R, 19G, 19B are applied on the dielectric layer 17 on the address electrodes 16R, 16G, 16B and the side walls of the barrier ribs 18. The phosphors 19R, 19G, 19B are exited by the discharge between the X electrode 11 and the Y electrode 12 so that the light in each color is emitted.

The front glass substrate 10 and the rear glass substrate 15 are sealed in a manner that the protective layer 14 and the barrier rib 18 are in contact, thereinside (the discharge space between the front glass substrate 10 and the rear glass substrate 11) is sealed a discharge gas such as Ne—Xe at a pressure of approximately 66.4 kPa (500 Torr), and whereby the plasma display panel is configured.

FIG. 3 is a cross-sectional view showing a configuration example of the plasma display panel 1 in this embodiment. In FIG. 3, the same numerals and symbols are used for the same components as the components shown in FIG. 2. In FIG. 3, there is shown only a cross section of a rear glass substrate 15 side in the plasma display panel 1 as seen from a direction perpendicular to a direction in which the address electrodes 16R, 16G, 16B extend.

On the rear glass substrate 15 are disposed the address electrodes 16R, 16G, 16B, which are covered by the dielectric layer 17. On both sides of the address electrodes 16R, 16G, 16B are disposed the barrier ribs 18. On the dielectric layer 17 on the address electrodes 16R, 16G, 16B and the side surfaces of the barrier ribs 18 are separately applied the phosphor layers 19R, 19G, 19B which emits light in red, green and blue on being exited by the ultraviolet ray.

Here, in the plasma display panel 1 in this embodiment, the barrier rib 18 is constituted with a colored glass which selectively absorbs a light emission spectrum of the red phosphor layer 19R and inside the barrier rib 18 there is dispersed a pigment (a pigment particle) for coloring so as to selectively absorb the light emission spectrum of the red phosphor layer 19R.

For example, the barrier rib 18 is constituted with a cyan colored glass or a colored glass in a mixed color of green and blue. The barrier rib 18 can be manufactured in a method similar to a conventional method, with a green pigment and a blue pigment being added to a barrier rib material. For example, there is a method in which a barrier rib forming material including a green material and a blue material is applied on the dielectric layer 17 of the rear glass substrate 15 and dried, and thereafter the material is cut into a barrier rib shape by a sand blast method and then baked. There is also a method in which a barrier rib forming photosensitive material including a green material and a blue material, for example, are applied on the dielectric layer 17 of the rear glass substrate 15, and thereafter, with a predetermined mask being used, the material is exposed and developed and then baked.

As the green material added to the barrier rib forming material, there are green pigments such as chromium oxide (Cr₂O₅) and cobalt green (CoO.nZnO) while as the blue material there are blue pigments such as cupric oxide (CuO) and cobalt oxide (CoO). It should be noted that the green material and the blue material are not limited thereto, and there is no restriction in particular to the kind of the green material and the blue material. A well-known green material and blue material may be combined arbitrarily and used, and it is enough that the green material of at least one or more kinds and the blue material of at least one or more kinds are included as the barrier rib material. However, since a heat is added at a time of formation of the barrier rib, it is desirable that an inorganic material being stable to the heat is used.

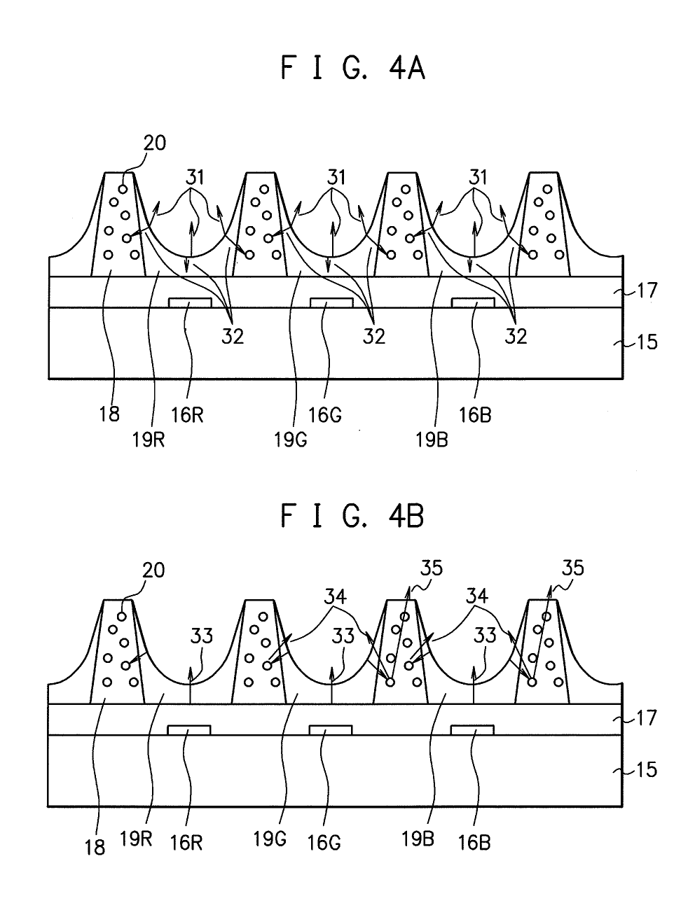

A display light of the plasma display panel 1 configured as above will be described with reference to FIG. 4A and FIG. 4B. In FIG. 4A and FIG. 4B, the same numerals and symbols are used for the same components as the components shown in FIG. 3. FIG. 4A and FIG. 4B show operations of the barrier rib 18 and the dielectric layer 17 to the light generated in the plasma display panel 1. In FIG. 4A and FIG. 4B, a numeral “20” denotes a pigment particle dispersed inside the barrier rib 18.

The light emission in the plasma display panel 1 is performed by excitation light emission of the red, green and blue phosphors by the ultraviolet ray generated by the discharge. As shown in FIG. 4A, the light radiated from the phosphor can be classified into a light 31 emitted near a surface of the phosphor and directed to a front surface (a front glass substrate 10 side) and a light 32 emitted near the surface of the phosphor and directed to a rear side (a rear glass substrate 15 side or the like) of the phosphor layer.

The light 32 directed to the rear side of the phosphor layer is reflected by the rear glass substrate 15 or the dielectric layer 17, or proceeds in a barrier rib direction and reflected by the barrier rib 18. In other words, as shown in FIG. 4B, there exist a light 33 which is reflected by the rear glass substrate 15 or the dielectric layer 17 and directed to the front surface and a light 34 which is reflected by the barrier rib 18 and directed to the front surface. There also exists a light 35 which transmits the barrier rib 18.

The display light of the plasma display panel 1 is determined by a sum of the light 31, which is shown in FIG. 4A, emitted near the surface of the phosphor and directed to the front surface, the light 33 proceeding to the rear side of the phosphor layer and reflected by the rear glass substrate 15 or the dielectric layer 17 and directed to the front surface, the light 34 reflected by the barrier rib 18 and directed to the front surface, and the light 35 transmitting the barrier rib 18.

In this embodiment, by constituting the barrier rib 18 with the colored glass which selectively absorbs the light emission spectrum of the red phosphor layer 19R as stated above, the barrier rib 18 operates to weaken the reflected light 34 from the barrier rib 18 as for the light emission by the red phosphor layer 19R, and consequently, weakens red luminance. For example, if the barrier rib 18 is constituted with the cyan colored glass or the colored glass in the mixed color of green and blue, the barrier rib 18 weakens the red luminance and operates to enhance the reflected light 34 from the barrier rib 18 as for the light emission by the green and blue phosphor layers 19G, 19B, and consequently enhances green luminance and blue luminance.

In other words, by constituting the barrier rib 18 with the colored glass which selectively absorbs the light emission spectrum of the red phosphor layer 19R to weaken a light emitting intensity by the red phosphor layer 19R, a difference in a light emission characteristic from the green and blue phosphor layers 19G, 19B becomes small. Therefore, in this embodiment, a good color balance can be maintained even though a film thickness of each of the phosphor layers 19R, 19G, 19B is approximately equal, the film thickness of the red phosphor layer 19R being thicker and the film thicknesses of the green and blue phosphor layers 19G, 19B being thinner compared with those in a conventional plasma display panel in which the color balance is maintained by differentiating the thicknesses of the phosphor films.

Consequently, in the plasma display panel 1, without varying the structure by each color, it is possible to reduce the difference in the discharge characteristic such as a discharge inception voltage in the cell of each color and to regularize the discharge characteristics, so that a driving margin can be increased and the good color balance can be maintained. Further, since the differences in the film thickness among the respective phosphor layers 19R, 19G, 19B become small, it is also possible to prevent the phosphor formed near an upper portion of the barrier rib from falling off in a phosphor layer with a thin film thickness, so that a plasma display panel with a good uniformity also in a structure of a cell can be provided.

Further, by using a barrier rib in which a chromaticity coordinate of a reflected light in an event that a white light is radiated on the barrier rib 18 is in a range of 0.05≦x≦0.20 and 0.30≦y≦0.45 in particular, reflectivity to the green light and the blue light rises so that a color temperature and luminance of white color can be improved.

In the above embodiment, the entire barrier rib 18 is constituted with the colored glass which selectively absorbs the light emission spectrum of the red phosphor layer 19R, but a part of the barrier rib 18 can be constituted with the colored glass which selectively absorbs the light emission spectrum of the red phosphor layer 19R.

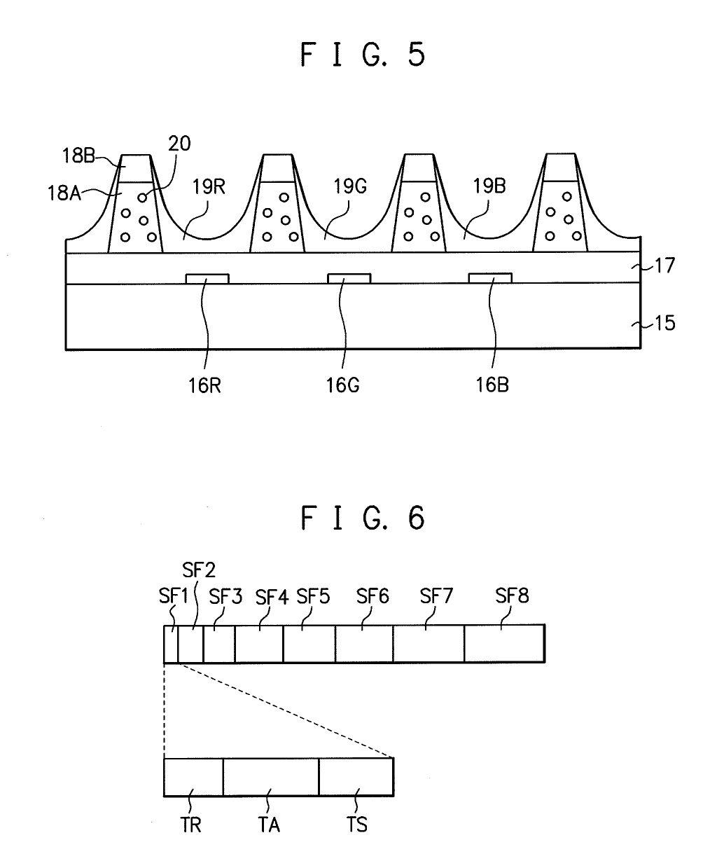

For example, a barrier rib can be configured as shown in FIG. 5. FIG. 5 is a cross-sectional view showing another configuration example of the plasma display panel in this embodiment. In FIG. 5, the same numerals and symbols are used for the same components as components shown in FIG. 3 and redundant description will be refrained. In FIG. 5, similarly to FIG. 3, there is shown only a cross section of the rear glass substrate 15 side in the plasma display panel 1 as seen from the direction perpendicular to the direction in which address electrodes 16R, 16G, 16B extend.

In FIG. 5, a part 18A of the barrier rib is constituted with a colored glass which selectively absorbs the light emission spectrum of the red phosphor layer 19R and a barrier rib upper layer portion 18B being a part of the barrier rib is constituted with a black barrier rib to which light transmission from the outside is hard to occur. A numeral “20” depicts a pigment particle dispersed inside the part 18A of the barrier rib. By configuring the barrier rib as above, an effect similar to that in the above embodiment can be obtained and a contrast can be improved since a reflection of an external light is decreased.

In order to obtain a barrier rib structure shown in FIG. 5, barrier rib forming materials are applied in two steps. Namely, first, a barrier rib forming material including a green material and a blue material is applied on the dielectric layer 17 of the rear glass substrate 15 and thereon is applied a barrier rib material including a black material (a black pigment) so that two barrier rib forming material layers are formed, and then the barrier rib structure is formed by a method such as a sand blast method.

As the black barrier rib material, oxides such as iron (Fe), manganese (Mn), nickel (Ni) and copper (Cu) can be used. It should be noted that the black barrier rib material is not limited thereto and there is not restriction in particular, but it is desirable that an inorganic material being stable against heat is used.

In the above-described plasma display panel 1 in this embodiment, further, the dielectric layer 17 on the rear glass substrate 15 can be constituted by using a low-melting glass including at least one of a green coloring pigment or a blue coloring pigment or a low-melting glass including a black coloring pigment. For example, in a case that the dielectric layer 17 is constituted with the low-melting glass including at least one of the green coloring pigment and the blue coloring pigment, the red luminance can be further weakened and the green luminance and the blue luminance can be further enhanced. Therefore, the color temperature and the white luminance can be further improved.

In a case that the dielectric layer 17 is constituted with the low-melting glass including the black coloring pigment, for example, the reflection from the external light can be further reduced to improve the contrast.

Next, a drive method of a plasma display device in this embodiment will be described.

FIG. 6 is a diagram showing an example of a tone drive sequence of the plasma display device in this embodiment. In this embodiment, an image is formed at 60 fields per second, for example. One field is constituted with a plurality of sub-fields having predetermined weights of luminance respectively, and a desired tone display is performed by a combination of the respective sub-fields.

For example, in the example shown in FIG. 6, one field is formed by eight sub-fields (a first sub-field SF1, a second sub-field SF2, . . . and an eighth sub-field SF8) having luminance weights of power of 2. In the first to eighth sub-fields SF1 to SF8, a ratio of a number of sustain discharges is 1:2:4:8:16:32:64:128, and it is possible to perform a display of 256 tones. Incidentally, a number of the sub-fields and a weight of each sub-field can be variously combined.

Each of the sub-fields SF1 to SF8 is constituted with a reset period (an initialization process) TR in which wall charges of all the cells constituting a display screen are uniformized, an address period (an address process) TA in which a cell to light is selected, and a sustain (a sustain discharge) period (a display process) TS in which the selected cell is discharged (lighted) by a number of times corresponding to luminance (weight of each sub-field)

During the reset period TR, a predetermined voltage is applied on X electrodes Xi and Y electrodes Yi constituting all display lines to make all the cells Cij generate reset discharges to perform initialization.

During the address period TA, a selection of light emission or non light emission of each cell Cij is performed by addressing. During the address period TA, scan pulses are sequentially scanned and applied to Y electrodes Y1, Y2 and so on, and in correspondence with the scan pulse, an address pulse is applied to a selected address electrode Aj, and whereby a cell Cij to emit light is made to generate an address discharge. More specifically, when the address pulse is generated in correspondence with the scan pulse, the address discharge occurs between the address electrode Aj and the Y electrode Yi, and with that address discharge being a pilot, a discharge between the X electrode Xi and the Y electrode Yi occurs. Hereby, a negative electric charge is accumulated in the X electrode Xi and a positive electric charge is accumulated in the Y electrode Yi, and as a consequence, in the selected cell is formed a wall charge of an amount enabling the sustain discharge which is performed during the subsequent sustain period TS.

During the sustain period TS, sustain pulses reverse to each other are applied to between the X electrode Xi and the Y electrode Yi, and a sustain discharge is performed between the X electrode Xi and the Y electrode Yi of the cell selected during the address period TA, so that the light emission is performed. In the respective sub-fields SF1 to SF8 shown in FIG. 6, numbers of sustain pulses applied to the X electrode Xi and the Y electrode Yi (light emission numbers in the respective sub-fields) are different. Accordingly, it is possible to determine a tone value by selecting light emission or non light emission in the sub-fields SF1 to SF8 appropriately for the respective display cell Cij.

According to the present invention, by constituting a barrier rib with a colored glass which selectively absorbs a light emission spectrum of a red phosphor layer, it is possible to weaken a light emitting intensity of the red phosphor layer to decrease a difference in a light emission characteristic from a phosphor layer of another color. Hereby, without varying a cell structure by each color, it is possible to reduce a difference in a discharge characteristic, so that an increased driving margin and a good color balance can be realized.

It should be noted that the present invention can be applied to plasma display devices of various forms and it is possible to widely apply the present invention to, for example, a display device such as a personal computer and a work station, a flat type wall-mounted television set, or a plasma display device used as a device for displaying an advertisement, information and so on.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display panel comprising:
a discharge gas sealed in a gap between a front side substrate and a rear side substrate opposed to each other;
barrier ribs partitioning a gas-sealed space into a discharge cell array, said barrier ribs being disposed above an inner surface of one of the substrates; and
at least three kinds of phosphor layers of red, green and blue separately applied and provided in the gas-sealed space responding to a discharge cell,
wherein said barrier rib is constituted with a colored glass selectively absorbing a light emission spectrum of said red phosphor layer.

2. The plasma display panel according to claim 1, wherein thicknesses of said phosphor layers are approximately equal irrespective of emitted colors.

3. The plasma display panel according to claim 2, wherein said barrier rib is constituted with a cyan colored glass or a colored glass in a mixed color of green and blue.

4. The plasma display panel according to claim 2, wherein, in said barrier rib, a chromaticity coordinate of a reflected light of said barrier rib is in a range of 0.05≦x≦0.20 and 0.30≦y≦0.45.

5. The plasma display panel according to claim 2, wherein a material for said barrier rib includes a green material and a blue material.

6. The plasma display panel according to claim 2, further comprising:
a plurality of electrodes generating surface discharges and a first dielectric layer covering said plurality of electrodes, said plurality of electrodes and said first dielectric layer being provided on an inner surface of the front side substrate; and
a plurality of address electrodes generating address discharges and disposed in a direction intersecting said electrodes for the surface discharge, and a second dielectric layer covering said plurality of address electrodes, said plurality of address electrodes and said second dielectric layer being provided on the rear side substrate,
wherein said barrier rib is provided on said second dielectric layer.

7. The plasma display panel according to claim 6, wherein an upper layer portion of said barrier rib is black.

8. The plasma display panel according to claim 6, wherein said second dielectric layer is constituted with a dielectric including at least one of a green coloring pigment and a blue coloring pigment.

9. The plasma display panel according to claim 6, wherein said second dielectric layer is constituted with a dielectric including a black coloring pigment.

10. The plasma display panel according to claim 1, wherein said barrier rib is constituted with a cyan colored glass or a colored glass in a mixed color of green and blue.

11. The plasma display panel according to claim 1, wherein, in said barrier rib, a chromaticity coordinate of a reflected light of said barrier rib is in a range of 0.05≦x≦0.20 and 0.30≦y≦0.45.

12. The plasma display panel according to claim 1, wherein a material for said barrier rib includes a green material and a blue material.

13. The plasma display panel according to claim 1, further comprising:
a plurality of electrodes generating surface discharges and a first dielectric layer covering said plurality of electrodes, said plurality of electrodes and said first dielectric layer being provided on an inner surface of the front side substrate; and
a plurality of address electrodes generating address discharges and disposed in a direction intersecting said electrodes for the surface discharge, and a second dielectric layer covering said plurality of address electrodes, said plurality of address electrodes and said second dielectric layer being provided on the rear side substrate,
wherein said barrier rib is provided on said second dielectric layer.

14. The plasma display panel according to claim 13, wherein an upper layer portion of said barrier rib is black.

15. The plasma display panel according to claim 13, wherein said second dielectric layer is constituted with a dielectric including at least one of a green coloring pigment and a blue coloring pigment.

16. The plasma display panel according to claim 13, wherein said second dielectric layer is constituted with a dielectric including a black coloring pigment.
